(19) United States
(12) Patent Application Publication
(10) Pub. No.: US 2023/0178832 A1
(43) Pub. Date: Jun. 8, 2023

(54) BUTTON BATTERY OR CYLINDRICAL BATTERY

(71) Applicant: Guangdong Mic-Power New Energy Co., Ltd., Guangdong (CN)

(72) Inventor: Zhiyong CHEN, Guangdong (CN)

(21) Appl. No.: 17/923,720

(22) PCT Filed: Dec. 16, 2020
(86) PCT No.: PCT/CN2020/136784

§ 371 Date: Nov. 7, 2022

(30) Foreign Application Priority Data
May 6, 2020 (CN) 202020730535.5

(51) Int. Cl. H01M 50/186; H01M 50/109; H01M 50/107; H01M 50/166; H01M 50/538; H01M 50/46; H01M 50/533

(52) U.S. Cl. CPC H01M 50/186; H01M 50/109; H01M 50/107; H01M 50/166; H01M 50/538; H01M 50/46; H01M 50/533

(57) ABSTRACT

Disclosed is a button battery or cylindrical battery, including: a first shell (1), the first shell (1) comprising a first annular sidewall (11) and a first end cover (12), wherein the first annular sidewall (11) is hermetically provided with the first end cover (12) at one end and is open at the other end; a second shell (2), the second shell (2) comprising a second annular sidewall (21) and a second end cover (22), wherein the second annular sidewall (21) is hermetically provided with the second end cover (22) at one end and is open at the other end; the first shell (1) and the second shell (2) are connected together with their open ends opposite to each other, the first annular sidewall (11) is sleeved outside the second annular sidewall (21), an insulating sleeve (3) is provided between the first annular sidewall (11) and the second annular sidewall (21), a first annular protrusion (23) protruding toward the insulating sleeve (3) is formed in the circumferential direction of the outer surface of the second annular sidewall (21), and the first annular protrusion (23) abuts against the insulating sleeve (3).

### TECHNICAL FIELD

The present disclosure relates to the technical field of electric energy storage, in particular to a button battery or cylindrical battery.

### BACKGROUND

In an existing button battery, in order to ensure the sealing performance of the battery, a sealing rubber ring is connected with a metal housing at the negative electrode through a sealant. However, after a long time, volatilization of the sealant may occur, which tends to cause the sealing rubber ring to fall off from the metal housing at the negative electrode, thus failing to achieve the sealing performance and resulting in leakage.

Therefore, it is necessary to provide a new technical solution to solve at least one of the above technical problems.

### SUMMARY

One objective of the present disclosure is to provide a new technical solution of a button battery or cylindrical battery.

In one aspect of the present disclosure, a button battery or cylindrical battery is provided, including: a first shell, the first shell including a first annular sidewall and a first end cover, wherein the first annular sidewall is hermetically provided with the first end cover at one end and is open at the other end; a second shell, the second shell including a second annular sidewall and a second end cover, wherein the second annular sidewall is hermetically provided with the second end cover at one end and is open at the other end; the first shell and the second shell are connected together with their open ends opposite to each other, the first annular sidewall is sleeved outside the second annular sidewall, an insulating sleeve is provided between the first annular sidewall and the second annular sidewall, a first annular protrusion protruding toward the insulating sleeve is formed in the circumferential direction of the outer surface of the second annular sidewall, and the first annular protrusion abuts against the insulating sleeve.

Optionally or alternatively, a second annular protrusion protruding toward the insulating sleeve is formed in the circumferential direction of the inner surface of the first annular sidewall, and the second annular protrusion abuts against the insulating sleeve.

Optionally or alternatively, the first annular protrusion and the second annular protrusion are staggered in an axial direction of the first shell.

Optionally or alternatively, a distance between the first annular protrusion and the second annular protrusion is less than or equal to 4 mm.

Optionally or alternatively, the first annular protrusion is provided with strip-like through-holes or grooves which extend in an axial direction of the first shell.

Optionally or alternatively, the first shell and the second shell enclose a receiving cavity in which a roll-core is provided, the roll-core is connected with the first shell and the second shell respectively via a tab, and one end surface of the roll-core and the first end cover are provided with an insulating spacer therebetween, or the end surface and the second end cover are provided with an insulating film spacer therebetween.

Optionally or alternatively, the roll-core includes a first insulating film, a second insulating film, a positive material and a negative material, the positive material being sandwiched between the first insulating film and the second insulating film, and the negative material being located outside the first insulating film or the second insulating film, wherein during winding, the negative material is located on the side close to a winding center and the positive material is located on the side away from the winding center.

Optionally or alternatively, the positive material and the negative material include a current collector and an electrode active material covering both surfaces of the current collector, the negative material has an extension with respect to the positive material at a tail of the roll-core, and a surface of the extension away from the winding center forms a vacant area which surrounds the roll-core by at least one turn.

Optionally or alternatively, the first insulating film and/or the second insulating film forms an extension with respect to the negative material at the tail of the roll-core, and the extension surrounds the roll-core by at least one turn.

Optionally or alternatively, further including a central post, and the first insulating film, the second insulating film, the positive material and the negative material wind around the central post.

In the button battery or cylindrical battery of the present disclosure, since the first annular protrusion protruding toward the insulating sleeve is formed in the circumferential direction of the outer surface of the second annular sidewall, the first annular protrusion abuts against and thus presses against the insulating sleeve so that the insulating sleeve abuts against the inner surface of the first annular sidewall to close the gap between first shell and second shell, therefore improving the sealing of the button battery or cylindrical battery.

Other features and advantages of the present disclosure will become apparent from the following detailed description of exemplary embodiments of the present disclosure with reference to the accompanying drawings.

### BRIEF DESCRIPTION OF THE DRAWINGS

The accompanying drawings, which constitute a part of the description, illustrate embodiments of the present disclosure and, together with the description thereof, serve to explain the principles of the present disclosure.

FIG. 1 is a schematic structural section view of a button battery or cylindrical battery according to an embodiment of the present disclosure.

FIG. 2 is a schematic structural view of a roll-core of the button battery or cylindrical battery according to the embodiment of the present disclosure.

FIG. 3 is a schematic structural external view of the button battery or cylindrical battery according to the embodiment of the present disclosure.

### DESCRIPTION OF REFERENCE SIGNS

1: first shell; 11: first annular sidewall; 111: groove; 12: first end cover; 13: second annular protrusion; 2: second shell; 21: second annular sidewall; 22: second end cover; 23: first annular protrusion; 3: insulating sleeve; 4: roll-core; 41: first insulating film; 42: second insulating film; 43: positive material; 44: negative material; 5: tab; 6: central post; 7: insulating spacer; 8: insulating film spacer.

### DETAILED DESCRIPTION

Various exemplary embodiments of the present invention are described in detail hereinafter with reference to the accompanying drawings. It should be noted that unless otherwise specified, relative arrangement, numerical expressions and values of parts and steps described in the embodiments do not limit the scope of the present invention.

The following description of the at least one exemplary embodiment is actually merely illustrative and never constitutes any limitation to the present invention and application or use thereof.

Technologies and equipment known to those of ordinary skill in the related field may not be discussed in detail, but, where appropriate, the technologies and equipment should be regarded as a part of the specification.

In all the examples shown and discussed herein, any specific value should be interpreted as merely exemplary rather than a limitation. Therefore, other examples of the exemplary embodiments may have different values.

It should be noted that similar reference numerals and letters represent similar items in the accompanying drawings below. Therefore, once a certain item is defined in one drawing, it is unnecessary to further discuss the item in the subsequent drawings.

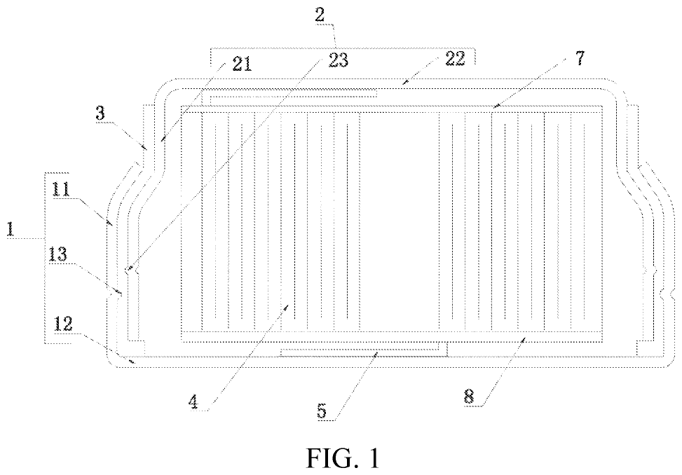

As shown in FIG. 1, a button battery or cylindrical battery is disclosed by an embodiment of the present disclosure, including a first shell 1, the first shell 1 including a first annular sidewall 11 and a first end cover 12, wherein the first annular sidewall 11 is hermetically provided with the first end cover 12 at one end and is open at the other end;

a second shell 2, the second shell 2 including a second annular sidewall 21 and a second end cover 22, wherein the second annular sidewall 21 is hermetically provided with the second end cover 22 at one end and is open at the other end;

the first shell 1 and the second shell 2 are connected together with their open ends opposite to each other, the first annular sidewall 11 is sleeved outside the second annular sidewall 21, and the first annular sidewall 11 and the second annular sidewall 21 are provided with an insulating sleeve 3 therebetween, whose height is above that of the first annular sidewall 11 to isolate the first annular sidewall 11 from the second annular sidewall 21 and thus prevent the first annular sidewall 11 and the second annular sidewall 21 from being short-circuited. One end of the first annular sidewall 11 is bent toward the insulating sleeve 3 to reduce the caliber. The annular inner surface at the one end of the first annular sidewall 11 is pressed against the insulating sleeve 3 so that the insulating sleeve 3 abuts against the outer wall surface of the second annular sidewall 21. Then, a sealing ring is provided at the one end of the first annular sidewall 11 to form a first seal for the button battery or cylindrical battery.

As shown in FIG. 1, a first annular protrusion 23 protruding toward the insulating sleeve 3 is formed in the circumferential direction of the outer surface of the second annular sidewall 21, abuts against the insulating sleeve 3 and presses against the insulating sleeve 3 so that the insulating sleeve 3 abuts against the inner surface of the first annular sidewall 11 to close the gap between first shell 1 and second shell 2, thus forming a second seal for the button battery or cylindrical battery. The second seal is located between the first seal and the other end of the first annular sidewall 11. With the two seals, the button battery or cylindrical battery of the present embodiment achieves the effect of improving the sealing of the button battery or cylindrical battery.

Of course, the button battery or cylindrical battery of the present embodiment has good sealing without the sealing ring since the first annular protrusion 23 abuts against the insulating sleeve 3 and presses against the insulating sleeve 3 so that the insulating sleeve 3 abuts against the inner surface of the first annular sidewall 11 which can also block the leakage of the electrolyte inside.

In addition, since the first annular protrusion 23 as the second seal and the first seal are staggered, a portion of the insulating sleeve 3 abuts against the outer surface of the second annular sidewall 21 and the other portion thereof abuts against the inner surface of the first annular sidewall 11 so that the sidewall of the insulating sleeve 3 is increased in cross-sectional width to block the leakage of liquid from the battery, causing the insulating sleeve 3 to have both the function of preventing short circuit and the effect of sealing. In this way, the insulating sleeve 3 between the first seal and the second seal functions as a third seal, which further improves the sealing of the button battery or cylindrical battery.

As shown in FIG. 1, in one embodiment, a second annular protrusion 13 protruding toward the insulating sleeve 3 is formed in the circumferential direction of the inner surface of the first annular sidewall 11, abuts against the insulating sleeve 3 and presses against the insulating sleeve 3 so that the insulating sleeve 3 abuts against the outer surface of the second annular sidewall 21, thus forming a fourth seal for the button battery or cylindrical battery. In this way, the sealing of the button battery or cylindrical battery is further improved.

As shown in FIG. 1, in one embodiment, the first annular protrusion 23 and the second annular protrusion 13 are staggered in an axial direction of the first shell 1. Since the first annular protrusion 23 and the second annular protrusion 13 are staggered in an axial direction of the first shell 1, it can reduce the diameter of the button battery or cylindrical battery so as to reduce the overall size of the button battery or cylindrical battery and finally realize the application of the button battery or cylindrical battery in micro electronic devices.

In addition, since the first annular protrusion 23 and the second annular protrusion 13 are staggered in an axial direction of the first shell 1, a portion of the insulating sleeve 3 between the first annular protrusion 23 and the second annular protrusion 13 abuts against the outer surface of the second annular sidewall 21 and the other portion thereof abuts against the inner surface of the first annular sidewall 11 so that the sidewall of the insulating sleeve 3 is increased in cross-sectional width to block the leakage of liquid from the battery, therefore forming a fifth seal. In this way, the sealing of the button battery or cylindrical battery is further improved.

Of course, the arrangement of the first annular protrusion 23 and the second annular protrusion 13 is not limited to being staggered, and may be arranged to face each other. Those skilled in the art may set the arrangement of the first annular protrusion 23 and the second annular protrusion 13 according to actual needs.

In one embodiment, the distance between the first annular protrusion 23 and the second annular protrusion 13 is less than or equal to 4 mm. When the distance between the first annular protrusion 23 and the second annular protrusion 13 is less than or equal to 4 mm, the sealing performance of the second, third, fourth and fifth seals is optimal. Of course, the distance between the first annular protrusion 23 and the second annular protrusion 13 is not limited to be less than or equal to 4 mm, and may be 4 mm or more. Those skilled in the art may set the distance between the first annular protrusion 23 and the second annular protrusion 13 according to actual needs.

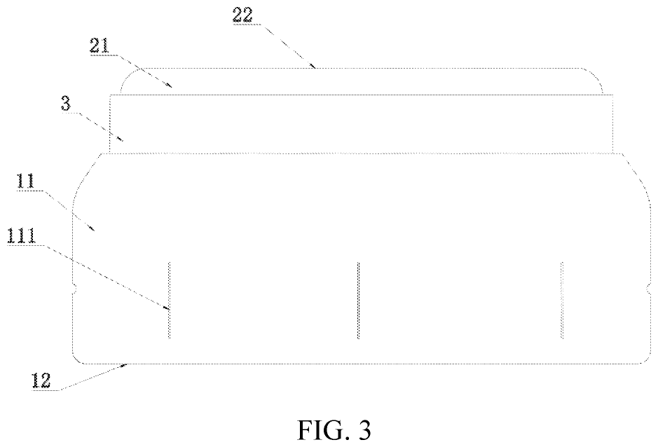

As shown in FIG. 3, in one embodiment, the first annular sidewall 11 is provided with through-holes or grooves. The through-holes or grooves on the first annular sidewall 11 enable that when the interior of the button battery or cylindrical battery is exposed to high temperature and high-pressure gas is generated, the button battery or cylindrical battery is prevented from occurrence of an explosion accident by releasing pressure in time through the through-holes or grooves.

For example, strip-like grooves 111 are provided on the first annular sidewall 11 and extend in an axial direction of the first shell 1.

The through-holes or grooves can be formed by a scribed line process, such that when the high-pressure gas inside the button battery or cylindrical battery reaches a preset pressure, it can automatically break along the scribed line to release the pressure. Preferably, the through-holes or grooves are provided between the first end cover 12 and the second annular protrusion 13 of the first shell 1. With the through-holes or grooves being between the first end cover 12 and the second annular protrusion 13, it is able to have the best explosion-proof performance.

As shown in FIG. 1, in one embodiment, the first shell 1 and the second shell 2 enclose a receiving cavity in which a roll-core 4 is disposed. The roll-core 4 is connected with the first shell 1 and the second shell 2 through a tab 5. An insulating spacer 7 is disposed between one end face of the roll-core 4 and the first end cover 12, or an insulating film spacer is disposed between the end face of the roll-core 4 and the second end cover 22. The insulating spacer 7 or the insulating film spacer 8 prevents the positive electrode and negative electrode of the roll-core 4 from being short-circuited.

For example, when the first end cover 12 is connected with the positive electrode via the tab 5, the insulating spacer 7 prevents the negative electrode of the roll-core 4 from being short-circuited to the first end cover 12.

For example, when the first end cover 12 is connected with the negative electrode via the tab 5, the insulating spacer 7 prevents the positive electrode of the roll-core 4 from being short-circuited to the first end cover 12.

For example, when the second end cover 22 is connected with the positive electrode via the tab 5, the insulating film spacer 8 prevents the negative electrode of the roll-core 4 from being short-circuited to the second end cover 22.

For example, when the second end cover 22 is connected with the negative electrode via the tab 5, the insulating film spacer 8 prevents the positive electrode of the roll-core 4 from being short-circuited to the second end cover 22.

As shown in FIG. 1, in one embodiment, an inner wall of the first end cover 12 and an inner wall of the second end cover 22 are respectively connected with the two tabs 5 in a one-to-one correspondence. The connection is any one of laser welding, resistance welding, and ultrasonic welding. Of course, the welding method is not limited to the above manners, which can be selected by those skilled in the art according to actual needs. The two tabs 5 are respectively connected with the positive electrode current collector and the negative electrode current collector in a one-to-one correspondence.

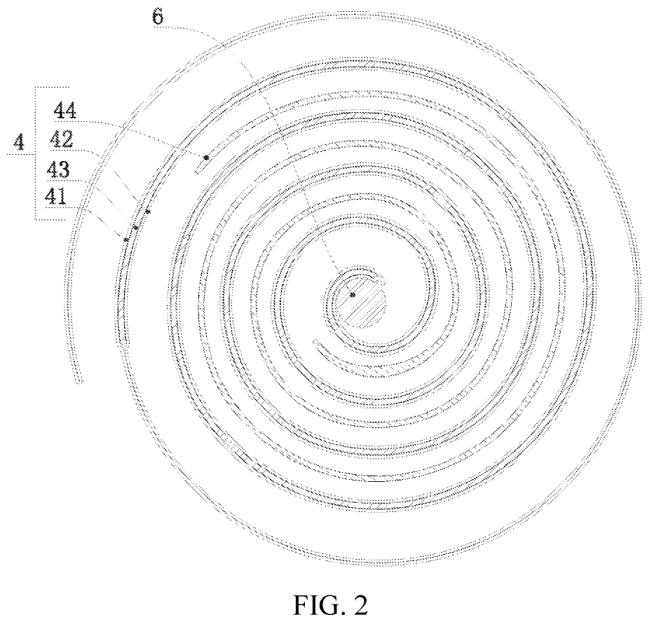

As shown in FIG. 2, in one embodiment, the roll-core 4 includes a first insulating film 41, a second insulating film 42, a positive material 43, and a negative material 44. The positive material 43 is sandwiched between the first insulating film 41 and the second insulating film 42. The first insulating film 41 and the second insulating film 42 function to prevent the positive electrode and the negative electrode of the roll-core 4 from being short-circuited.

The first insulating film 41 and the second insulating film 42 may be two independent insulating materials. The first insulating film 41 and the second insulating film 42 may also be integrally formed, for example, to form a pocket having an opening at at least one end, into which the positive material 43 extends.

For example, the insulating layer is made of insulating gummed paper or insulating adhesive tape.

The negative material 44 is located outside the first insulating film 41 or the second insulating film 42.

For example, the roll-core 4 is composed of the first insulating film 41, the positive material 43, the second insulating film 42 and the negative material 44 in order from the outside (away from the center) to the inside (close to the center).

For example, the roll-core 4 is composed of the second insulating film 42, the positive material 43, the first insulating film 41 and the negative material 44 in order from the outside to the inside.

Of course, the arrangement order of the roll-core 4 from the outside to the inside may also be the first insulating film 41, the negative material 44, the second insulating film 42 and the positive material 43. Those skilled in the art may set the arrangement order of the roll-core 4 from the outside to the inside according to actual needs.

During winding, the negative material 44 is located on the side close to the winding center and the positive material 43 is located on the side away from the winding center. The arrangement order of the positive material 43 and the negative material 44 during winding is not limited to the above embodiment, wherein the positive material 43 may be located on the side close to the winding center and the negative material 44 is located on the side away from the winding center. A person skilled in the art can set the arrangement order of the positive material 43 and the negative material 44 during winding according to actual needs.

In one embodiment, each of the positive material 43 and the negative material 44 includes a current collector and an electrode active material covering both surfaces of the current collector. The negative material 44 has an extension with respect to the positive material 43 at the tail of the roll-core 4, and the surface of the extension away from the winding center forms a vacant area which surrounds the roll-core 4 by at least one turn. The vacant area has no electrode active material therein for facilitating connection with the tab, and the vacant area surrounds the roll-core 4. When the vacant area surrounds roll-core 4 by one turn, it is possible to have the best anti-short circuit effect.

Both the positive material 43 and the negative material 44 are electrode active material. For example, the positive electrode active material is lithium cobaltate, lithium iron phosphate, or the like.

For example, the negative electrode active material is a carbon negative material or an alloy negative material.

For example, the carbon negative material is any one of artificial graphite, natural graphite, mesocarbon microbeads, petroleum coke, carbon fiber, and pyrolytic resin carbon.

For example, the alloy-based negative material is any one of a tin-based alloy, a silicon-based alloy, a germanium-based alloy, an aluminum-based alloy, an antimony-based alloy, and a magnesium-based alloy.

As shown in FIG. 2, in one embodiment, the first insulating film 41 and/or the second insulating film 42 form an extension with respect to the negative material 44 at the tail of the roll-core 4. The extension surrounds the roll-core 4. The extension of the first insulating film 41 and/or the second insulating film 42 has a length no less than that of the vacant area of the negative material 44. When the vacant area surrounds roll-core 4 by one turn, it is possible for the first insulating film 41 and/or the second insulating film 42 to have the best anti-short circuit effect.

For example, as shown in FIG. 2, the first insulating film 41 surrounds the outside of the roll-core 4 to enclose the periphery of the roll-core 4, thereby enhancing the insulation between the shell and the roll-core 4. In addition, the first insulating film 41 and/or the second insulating film 42 surrounds the outside of the roll-core 4 by one turn, thus increasing the thickness of the insulating layer and further enhancing the insulation between the shell and the roll-core 4.

In one embodiment, further including a central post 6. The first insulating film 41, the second insulating film 42, the positive material 43, and the negative material 44 wind around the central post 6. The central post 6 is cylindrical, and is made of an insulating material. The central post 6 enables the first insulating film 41, the positive material 43, the second insulating film 42, and the negative material 44 to be in closer contact during winding, and the overall shape of the roll-core 4 upon being rolled is more rounded to match the shape of the inner cavity of the button battery or cylindrical battery, thereby achieving the effect of easy and stable placement.

In one embodiment, at least one of the first insulating film 41 and the second insulating film 42 protrudes from the positive material 43 and the negative material 44, and the protruded portion forms an insulating protective layer between the first end cover 12 and the roll-core 4; and/or

the protruded portion forms an insulating protective layer between the second end cover 22 and the roll-core 4.

Preferably, both the first insulating film 41 and the second insulating film 42 protrude from the positive material 43 and the negative material 44. The protruded portion forms an insulating protective layer between the first end cover 12 and the roll-core 4, and forms an insulating protective layer between the second end cover 22 and the roll-core 4.

In this embodiment, there is no need to provide the insulating spacer 7 or the insulating film spacer 8 between the first end cover 12 and the roll-core 4. There is no need to provide the insulating spacer 7 or the insulating film spacer 8 between the second end cover 22 and the roll-core 4.

Although some specific embodiments of the present invention have been illustrated in detail through the examples, those skilled in the art should understand that the above examples are merely for illustration and are not intended to limit the scope of the present invention. Those skilled in the art should understand that the above embodiments may be modified without departing from the scope and spirit of the present disclosure. The scope of the present invention is defined by the appended claims.

1. A button battery or cylindrical battery, comprising:
a first shell, the first shell comprising a first annular sidewall and a first end cover, wherein the first annular sidewall is hermetically provided with the first end cover at one end and is open at the other end;
a second shell, the second shell comprising a second annular sidewall and a second end cover, wherein the second annular sidewall is hermetically provided with the second end cover at one end and is open at the other end;
the first shell and the second shell are connected together with their open ends opposite to each other, the first annular sidewall is sleeved outside the second annular sidewall, an insulating sleeve is provided between the first annular sidewall and the second annular sidewall, a first annular protrusion protruding toward the insulating sleeve is formed in the circumferential direction of the outer surface of the second annular sidewall, and the first annular protrusion abuts against the insulating sleeve.

2. The button battery or cylindrical battery of claim 1, wherein a second annular protrusion protruding toward the insulating sleeve is formed in the circumferential direction of the inner surface of the first annular sidewall, and the second annular protrusion abuts against the insulating sleeve.

3. The button battery or cylindrical battery of claim 2, wherein the first annular protrusion and the second annular protrusion are staggered in an axial direction of the first shell.

4. The button battery or cylindrical battery of claim 2, wherein a distance between the first annular protrusion and the second annular protrusion is less than or equal to 4 mm.

5. The button battery or cylindrical battery of claim 1, wherein the first annular protrusion is provided with strip-like through-holes or grooves which extend in an axial direction of the first shell.

6. The button battery or cylindrical battery of claim 1, wherein the first shell and the second shell enclose a receiving cavity in which a roll-core is provided, the roll-core is connected with the first shell and the second shell respectively via a tab, and one end surface of the roll-core and the first end cover are provided with an insulating spacer therebetween, or the end surface and the second end cover are provided with an insulating film spacer therebetween.

7. The button battery or cylindrical battery of claim 1, wherein the roll-core comprises a first insulating film, a second insulating film, a positive material and a negative material, the positive material being sandwiched between the first insulating film and the second insulating film, and the negative material being located outside the first insulating film or the second insulating film, wherein during winding, the negative material is located on the side close to a winding center and the positive material is located on the side away from the winding center.

8. The button battery or cylindrical battery of claim 7, wherein the positive material and the negative material include a current collector and an electrode active material covering both surfaces of the current collector, the negative material has an extension with respect to the positive material at a tail of the roll-core, and a surface of the extension away from the winding center forms a vacant area which surrounds the roll-core by at least one turn.

9. The button battery or cylindrical battery of claim 7, wherein the first insulating film and/or the second insulating film forms an extension with respect to the negative material at a tail of the roll-core, and the extension surrounds the roll-core by at least one turn.

10. The button battery or cylindrical battery of claim 7, further comprising a central post, and the first insulating film, the second insulating film, the positive material and the negative material wind around the central post.

11. The button battery or cylindrical battery of claim 6, wherein the tab is respectively connected with the first shell and the second shell by resistance welding, laser welding or ultrasonic welding.

12. The button battery or cylindrical battery of claim 11, wherein at least one of the first insulating film and the second insulating film protrudes from the positive material and the negative material, and a protruded portion forms an insulating protective layer between the first end cover and the roll-core; and/or
the protruded portion forms an insulating protective layer between the second end cover and the roll-core.
